(19) United States
(12) Patent Application Publication
(10) Pub. No.: US 2019/0271883 A1
(43) Pub. Date: Sep. 5, 2019

(54) BACKLIGHT MODULE WITH LIGHT REGULATION DEVICE

(71) Applicant: AU OPTRONICS CORPORATION, Hsin-Chu (TW)

(72) Inventors: Jian-Li Huang, Hsin-Chu (TW); Ming-Lung Chen, Hsin-Chu (TW); Chih-Ling Hsueh, Hsin-Chu (TW); Cheng-Chuan Chen, Hsin-Chu (TW)

(21) Appl. No.: 16/287,620

(22) Filed: Feb. 27, 2019

(30) Foreign Application Priority Data
Mar. 2, 2018 (TW) 107107126

(51) Int. Cl. G02F 1/1335

(52) U.S. Cl. CPC G02F 1/133611; G02F 1/133605; G02F 1/133603

(57) ABSTRACT

The present invention provides a backlight module, including a bottom plate, a plurality of light sources disposed on the bottom plate, one or more light regulation devices, and an optical film. The light regulation device is disposed on the bottom plate and covers at least one light source. Light generated by the light source is emitted out to reach the light regulation device, and the light regulation device regulates the light. The optical film is disposed on a side, opposite to the light source, of the light regulation device. By adjusting the sizes of a distance between the light sources, the width W of a top surface of the light regulation device, and a vertical distance OD between the bottom plate and the optical film, and relationships therebetween, light emitting uniformity of the backlight module can be improved; or a light field generated by the backlight module can be relatively easily fine-tuned by adjusting pattern distribution of light emitting windows on the top surface, to achieve the effect of uniformization.

### BACKGROUND

### Technical Field

The present invention relates to a backlight module with a light regulation device. Specifically, the present invention relates to a backlight module that has a light regulation device and that is provided with an optical film.

### Related Art

Flat and curved panel display devices have been widely used in various types of electronic devices, such as mobile phones, personal wearable devices, televisions, hosts of transportation vehicles, personal computers, digital cameras, and handheld video games. However, as specification requirements such as a resolution and a narrow bezel continue to increase, the optical design in the display device is also tested.

Using a liquid crystal display device as an example, its optical performance is usually closely related to a backlight module disposed behind a display panel. Using a conventional direct type backlight module as an example, to achieve a relatively good light mixing effect within a limited thickness range, a light regulation film is added above a light source, to partially reflect light emitted by the light source to different positions, and the light is then emitted out via light emitting holes. In addition, to further enhance the quality of the backlight generated by the backlight module, a diffusion sheet is further added above the light regulation film, to further achieve the effect of making the light uniformly distributed.

However, as a requirement for reducing the thickness of the backlight module becomes increasingly stricter, a distance between the light regulation film and the light source is gradually reduced. However, when the distance between the light regulation film and the light source is reduced, the space where the light source emits light for light mixing is also compressed. Consequently, the uniformity of the generated light is affected.

### SUMMARY

One objective of the present invention is to provide a backlight module, to increase the uniformity of light distribution.

The backlight module includes a bottom plate, a plurality of light sources disposed on the bottom plate, one or more light regulation devices, and an optical film. The light regulation device is disposed on the bottom plate and covers at least one light source. Light generated by the light source is emitted out to reach the light regulation device, and the light regulation device regulates the light. A plurality of light emitting windows is formed on a top surface of the light regulation device, to allow light to pass therethrough. The optical film is disposed on a side, opposite to the light sources, of the light regulation device, and has a bottom surface facing a reflective surface.

The light sources, the light regulation device, and the optical film are set to satisfy the following relational expression:

$$0 < \frac{P - W}{OD} < 2.3$$

where P is a distance between centers of two light sources that are adjacent in a first direction;
W is the width of the top surface in the first direction; and
OD is a vertical distance between the reflective surface and the bottom surface.

By adjusting the sizes of the distance P, the width W, and the vertical distance OD, and relationships therebetween, light emitting uniformity of the backlight module can be improved; or a light field generated by the backlight module can be relatively easily fine-tuned by adjusting pattern distribution of light emitting windows on the top surface, to achieve the effect of uniformization.

### BRIEF DESCRIPTION OF THE DRAWINGS

FIG. 1 is an exploded view of elements of an embodiment of the backlight module;

FIG. 2 is a cross-sectional view of an embodiment of the backlight module;

FIG. 3 is a diagram of distribution of light field strengths of embodiments in which there are different vertical distances OD;

FIG. 4A is a diagram of distribution of light field strengths of embodiments in which there are different widths W;

FIG. 4B is a diagram of distribution of light field strengths of embodiments in which there are different widths W;

FIG. 5A is a diagram of distribution of light field strengths of embodiments of a backlight module;

FIG. 5B is a diagram of distribution of light field strengths after patterns of light emitting windows are adjusted in the embodiments shown in FIG. 5A;

FIG. 5C is a diagram of distribution of light field strengths after patterns of light emitting windows are adjusted in the embodiments shown in FIG. 5B;

FIG. 6A is a diagram of distribution of light field strengths of embodiments of a backlight module;

FIG. 6B is a diagram of distribution of light field strengths after patterns of light emitting windows are adjusted in the embodiments shown in FIG. 6A;

FIG. 6C is a diagram of distribution of light field strengths after patterns of light emitting windows are adjusted in the embodiments shown in FIG. 6B;

FIG. 7A is a diagram of distribution of light field strengths of an embodiment of a backlight module; and

FIG. 7B is a diagram of distribution of light field strengths of an embodiment of a backlight module.

### DETAILED DESCRIPTION

The present invention provides a backlight module, which may be preferably applied to a display device. The display device preferably includes a non-self-emissive display panel, for example, a liquid crystal display panel or an electrophoretic display panel, and may be preferably applied to a computer display, a television, a monitor, and a vehicular host. In addition, the display device may also be applied to other electronic devices, for example, used as a display screen of a mobile phone, a digital camera, and a handheld electronic game device.

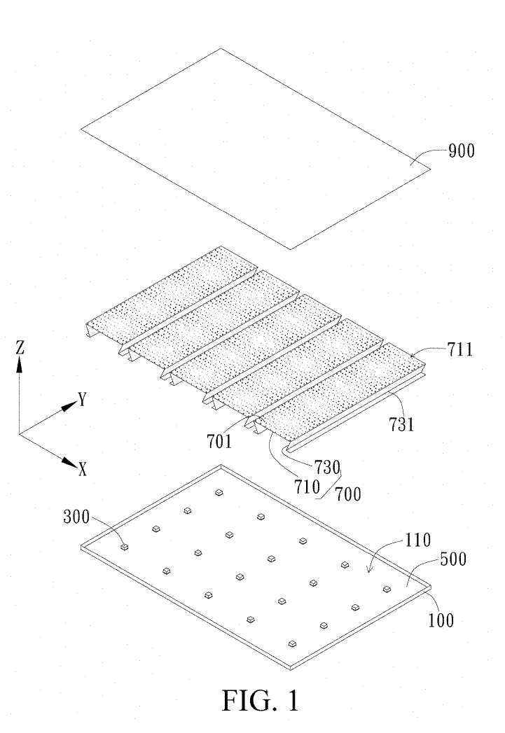

As shown in FIG. 1, the backlight module includes a bottom plate 100, a plurality of light sources 300, one or more light regulation devices 700, and an optical film 900. The bottom plate 100 may be preferably made of plastics or metal, for supporting the light sources 300 and circuits that control the light sources 300. The light source 300 is preferably a point light source, for example, a light-emitting diode. However, the present invention is not limited thereto. The light sources 300 are preferably disposed on the bottom plate 100 in a matrix of rows and columns, to form a plurality of rows and a plurality of columns in different directions. However, in different embodiments, the light sources 300 may also be arranged in other manners. As shown in FIG. 1, a reflective surface 110 is formed on the bottom plate 100, and may be preferably formed by superimposing a reflective sheet 500 and a body of the bottom plate 100. However, in different embodiments, the reflective surface 110 may also be formed by coating a reflective material on a surface of the body of the bottom plate 100. A part of light emitted by the light sources 300 may be directly or indirectly reflected by the reflective surface 110 for further use, to improve the use efficiency of light.

As shown in FIG. 1, the light regulation device 700 is disposed on the reflective surface 110, and covers at least one light source 300. Preferably, light generated by the light source 300 is emitted out to reach the light regulation device 700, and the light regulation device 700 regulates the light. For example, the light regulation device 700 may reflect part of light to different positions, and then allow the light to leave the light regulation device 700, to reach the above optical film 900, so that light distribution is relatively uniform. However, the present invention is not limited thereto. The light regulation device 700 may also adjust different characters of light, for example, adjust the advancing direction, the phase, or the color of the light.

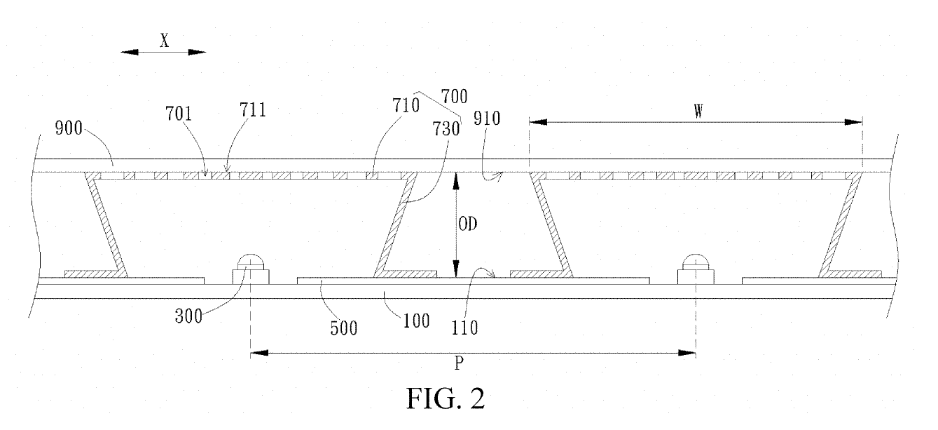

In this embodiment, the light regulation device 700 is formed into a strip shape, and has a top plate 710 and two opposite side plates 730. The top plate 710 is formed into an elongated rectangle to extend along rows or columns of the light sources 300, and the two side plates 730 are respectively extends out from opposite long ends of the top plate 710 and bend to each other. The top plate 710 has a top surface 711, and a plurality of light emitting windows 701 is preferably formed on the top surface 711, to allow light to pass therethrough. The light emitting window 701 is preferably a hollow punch hole, but may also be formed by a relatively transparent material. As shown in FIG. 1 and FIG. 2, the two side plates 730 may be parallel to each other, but may also spread outwardly or retract inwardly with respect to the top plate 710. Each side plate 730 has a positioning end 731 away from the top plate 710. The light regulation device 700 is disposed on the reflective sheet 500 by using the positioning end 731, and covers one row, a half row, one column, or a haft column of the light sources 300. However, in other embodiments, the light regulation device 700 may not have the side plates 730 and is formed into a sheet-like element, and is suspended above the light source 300 in other supporting manners.

As shown in FIG. 1 and FIG. 2, the optical film 900 is disposed on a side, opposite to the light sources 300, of the light regulation device 700, and has a bottom surface 910 facing the reflective surface 110. In this embodiment, the optical film 900 is preferably disposed on the top surface 711, and is supported by the light regulation device 700. However, in different embodiments, the optical film 900 may also be disposed above the light regulation device 700 by means of support by other structures such as a supporting pin. The optical film 900 preferably may be a diffusion film, a prism film, a brightness enhancement film, a polarizer film, or the like. However, the present invention is not limited thereto.

FIG. 2 is a cross-sectional view of an embodiment of a backlight module. In this embodiment, there is a distance P between centers of two light sources that are adjacent to each other in a first direction X. The first direction X is preferably a direction crosscutting a long edge of the light regulation device 700 and parallel to the reflective surface 110. In addition, the light sources 300 are arranged into a plurality of parallel rows or columns along the first direction X. However, the present invention is not limited thereto. In addition, the top surface 711 has a width W in the first direction X. In this embodiment, the top surface 711 is formed into a rectangle, and the width W is the length of a short edge of the top surface 711. In addition, as shown in FIG. 2, there is a vertical distance OD between the reflective surface 110 and the bottom surface 910 of the optical film 900. By adjusting the sizes of the distance P, the width W, and the vertical distance OD, and relationships therebetween, light emitting uniformity of the backlight module can be improved. The light field generated by the backlight module can be relatively easily fine-tuned by adjusting pattern distribution of the light emitting windows 701 on the top surface 711 to achieve the effect of uniformization.

### First Embodiment

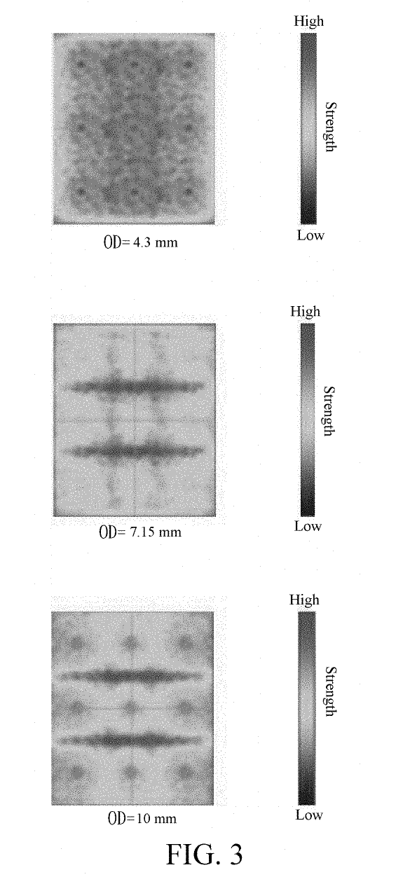

In this embodiment, simulation is performed by changing the size of the vertical distance OD on a premise that both the distance P and the width W are fixed, to determine the effect of the vertical distance OD on light field uniformity. As shown in FIG. 3, on a premise that both the distance P and the width W are fixed, distribution uniformity of a light field when the vertical distance OD is 4.3 mm is better than distribution uniformity of the light field when the vertical distance OD is 7.15 mm and 10 mm. It can be learned from the above that the vertical distance OD is indeed a factor that affects the distribution uniformity of the light field. Although in this embodiment, the distribution uniformity of a light field when the vertical distance OD is 4.3 mm is better, light field distribution when the vertical distance OD is 7.15 mm and 10 mm may still have particular regularity and stability comparing to light field distribution of other conventional backlight modules. For example, brightness distribution of the cross section thereof is milder than Gaussian distribution, or there is only a single brightness wave peak or wave trough between neighboring light sources. In this case, the light field still belongs to a type of a light field that can relatively easily achieve further uniformization by adjusting pattern distribution of the light emitting windows 701 on the top surface 711. For example, the pattern distribution of the light emitting windows 701 on the top surface 711 may be adjusted in manners such as changing the average aperture, the distribution positions, or density of the light emitting windows 701, or the aperture of the light emitting window 701 directly above the light sources.

### Second Embodiment

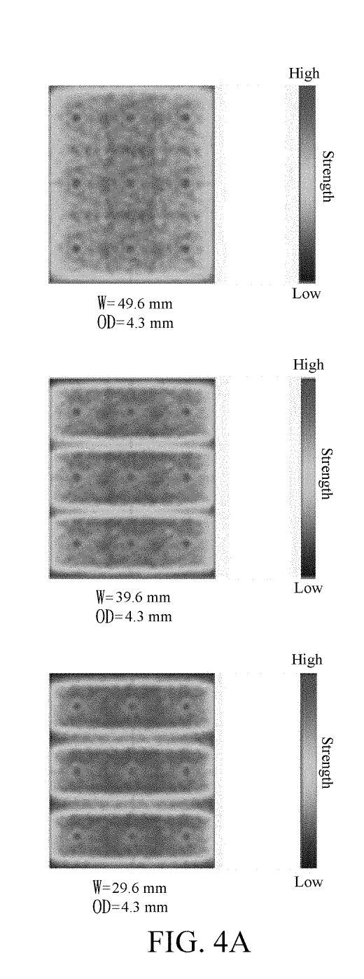

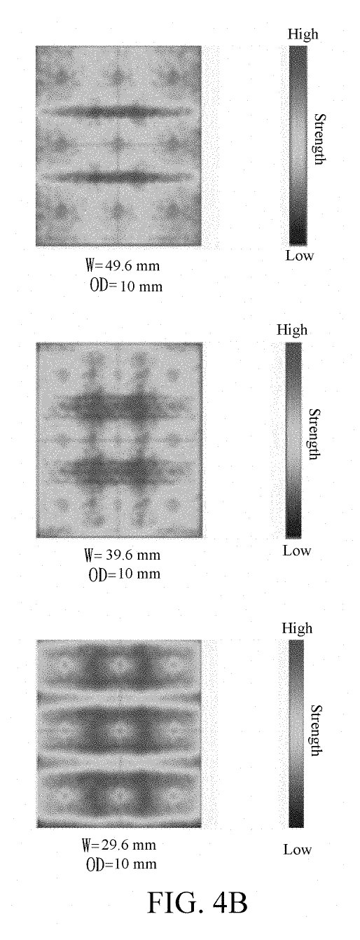

In this embodiment, simulation is performed by changing the size of the width W on a premise that both the distance P and the vertical distance OD are fixed, to determine the effect of the width W on light field uniformity. As shown in FIG. 4A, on a premise that both the distance P and the vertical distance OD are fixed, distribution uniformity of the light field when the width W is 49.6 mm is better than distribution uniformity of the light fields when the width W is 39.6 mm and 29.6 mm. It can be learned from the above that the width W is indeed a factor that affects the distribution uniformity of the light field. In this embodiment, the vertical distance OD is fixed at 4.3 mm, and the distance P, the width W, and the vertical distance OD satisfy the following relation:

$$\frac{P - W}{OD} = 2.23$$

However, in another varied embodiment, as shown in FIG. 4B, on a premise that the vertical distance OD is fixed at 10 mm, and the distance P is also fixed, it can be observed that the distribution uniformity of a light field when the width W is 49.6 mm is still optimal. On the other hand, when the width W is 39.6 mm, the distribution uniformity of a light field is also prominently increased to meet a requirement of a display device.

### Third Embodiment

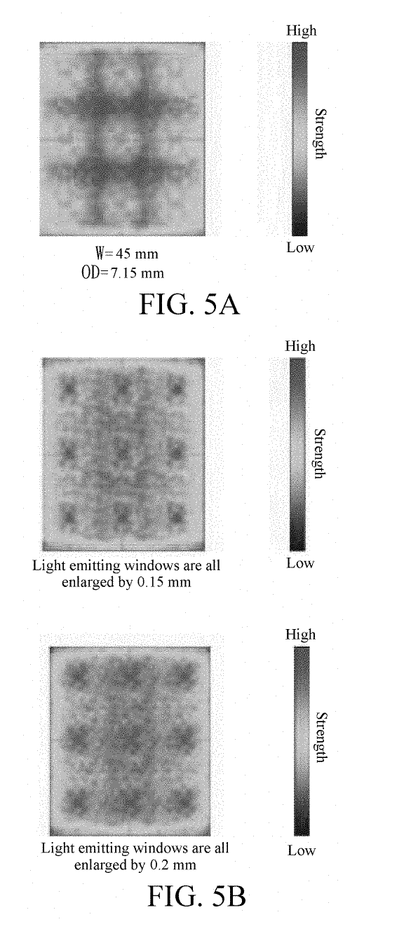

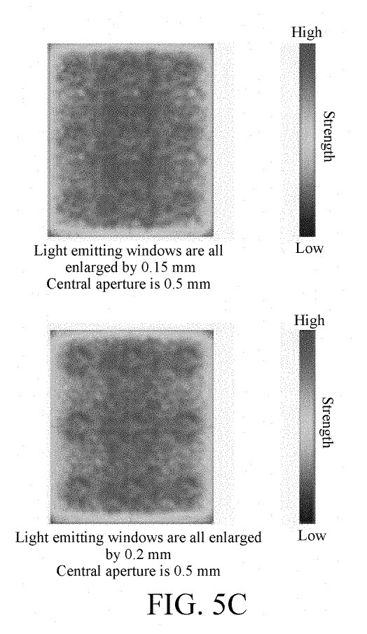

In this embodiment, the vertical distance OD is set to 7.15 mm, and OD/P is 0.12. Under this setting, when the width W is 45 mm, the generated light field belongs to the type that can easily achieve further uniformization by adjusting pattern distribution of the light emitting windows 701 on the top surface 711 can be generated, as shown in FIG. 5A. In this embodiment, the distance P, the width W, and the vertical distance OD satisfy the following relation:

$$\frac{P - W}{OD} = 1.98$$

In the setting of the embodiment shown in FIG. 5A, when pattern adjustment is further performed on the light emitting windows 701, for example, when the light emitting windows 701 are all enlarged by 0.15 mm and 0.2 mm, two light fields shown in FIG. 5B can be achieved. The two light fields are both prominently more uniform than the light field of FIG. 5A. In this case, if the central aperture of a light emitting window, corresponding to the light sources 300, of the light emitting windows 701 is further adjusted, for example, the aperture is adjusted to 0.5 mm, two light fields shown in FIG. 5C can be achieved, and are respectively more uniform than the two light fields of FIG. 5B. It can be learned from the above that when a suitable vertical distance OD, distance P, and width W are set, a relatively uniform light field or a light field that is relatively easily adjusted for uniformization can be generated.

### Fourth Embodiment

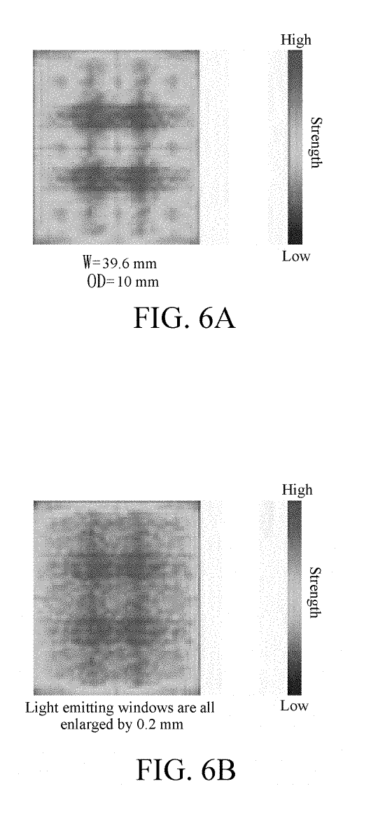

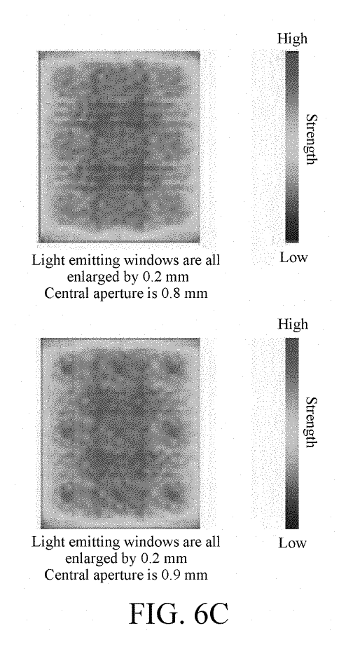

Manners of setting parameters in this embodiment are similar to those in the third embodiment, and only parameter values are adjusted. In this embodiment, the vertical distance OD is 10 mm, and OD/P is 0.17. Under this setting, the selected width W is 39.6 mm, so that the generated light field belongs to a type that can easily achieve further uniformization by adjusting pattern distribution of the light emitting windows 701 on the top surface 711, as shown in FIG. 6A. In this embodiment, the distance P, the width W, and the vertical distance OD satisfy the following relation:

$$\frac{P - W}{OD} = 1.96$$

In the setting of the embodiment shown in FIG. 6A, when pattern adjustment is further performed on the light emitting windows 701, for example, when the light emitting windows 701 are all enlarged by 0.2 mm, a light field shown in FIG. 6B can be achieved. The light field shown in FIG. 6B is prominently more uniform that the light field of FIG. 6A. In this case, if the central aperture of a light emitting window, corresponding to the light sources 300, of the light emitting windows 701 is further adjusted, for example, the aperture is adjusted to 0.8 mm or 0.9 mm, two light fields shown in FIG. 6C can be achieved, and are respectively more uniform than the two light fields of FIG. 6B. It can be learned from the above that when a suitable vertical distance OD, distance P, and width W are set, a relatively uniform light field or a light field that is relatively easily adjusted for uniformization can be generated.

By summarizing the foregoing embodiments, the distance P, the width W, and the vertical distance OD preferably satisfy the following relation:

$$0 < \frac{P - W}{OD} < 2.3$$

In addition, OD/P is preferably less than or equal to 0.2. By means of this setting, the backlight module can generate relatively uniform backlight. To say the least, even if the generated backlight is still not sufficiently uniform, a light field of the backlight module is relatively easily fine-tuned by adjusting pattern distribution (for example, the average aperture, the distribution positions and density, and the aperture of the light emitting window directly above the light sources) of light emitting windows 701 on the top surface 711, to achieve the effect of uniformization.

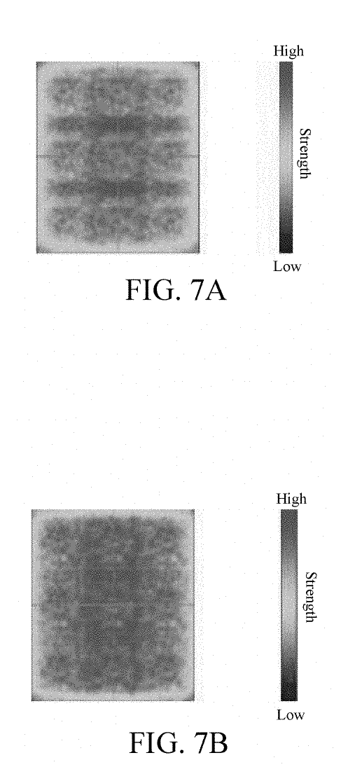

FIG. 7A and FIG. 7B further verify the foregoing relational expression. In the embodiment shown in FIG. 7A, the distance P, the width W, and the vertical distance OD satisfy the following relation:

$$\frac{P - W}{OD} = 1.76 .$$

As shown in FIG. 7A, it can be seen that distribution of light field strengths is relatively mild, and the light field belongs to a type of a light field that can relatively easily achieve further uniformization by adjusting pattern distribution of the light emitting windows 701 on the top surface 711. In the embodiment shown in FIG. 7B, the distance P, the width W, and the vertical distance OD satisfy the following relation:

$$\frac{P - W}{OD} = 2.04 .$$

As shown in FIG. 7B, it can be seen that the distribution of light field strengths is sufficiently uniform, and has satisfied a requirement for image display of a display device.

The present invention is described through the foregoing related embodiments. However, the foregoing embodiments are merely examples for implementing the present invention. It should be noted that the disclosed embodiments do not limit the scope of the present invention. On the contrary, amendments and equivalent settings that fall within the spirit and scope of the claims all fall within the scope of the present invention.

What is claimed is:

1. A backlight module, comprising:
a bottom plate, having a reflective surface;
a plurality of light sources, respectively disposed on the bottom plate, wherein the reflective surface is at least partially distributed on a periphery of the light sources;
at least one light regulation device, covering the light sources, wherein the regulation device has a top surface, and a plurality of light emitting windows is arranged on the top surface; and
an optical film, disposed on a side, opposite to the light sources, of the light regulation device, wherein the optical film has a bottom surface facing the reflective surface; and
the light sources, the light regulation device, and the optical film are set to satisfy the following relational expression:
$$0 < \frac{P - W}{OD} < 2.3$$
wherein P is a distance between centers of two light sources that are adjacent to each other in a first direction;
W is the width of the top surface in the first direction; and
OD is a vertical distance between the reflective surface and the bottom surface.

2. The backlight module according to claim 1, wherein the light sources, the light regulation device, and the optical film are set to satisfy the following relational expression:
$$\frac{P - W}{OD} = 2.23 .$$

3. The backlight module according to claim 1, wherein the light sources, the light regulation device, and the optical film are set to satisfy the following relational expression:
$$1.76 < \frac{P - W}{OD} .$$

4. The backlight module according to claim 1, wherein the light regulation device has:
a top plate; and
two side plates, respectively bent to extend out from two opposite ends of the top plate, wherein each side plate has a positioning end away from the top plate; and
the top surface is formed on the top plate

5. The backlight module according to claim 4, wherein the optical film is supported by the top surface.

6. The backlight module according to claim 1, wherein OD/P≤0.2.

7. The backlight module according to claim 1, wherein OD≤10 mm.

8. The backlight module according to claim 7, wherein OD≥4.3 mm.

9. The backlight module according to claim 1, wherein 39 mm≤W≤50 mm.

10. The backlight module according to claim 1, having a plurality of the light regulation devices, wherein the light sources are arranged into a plurality of parallel columns perpendicular to the first direction, and the light regulation devices respectively extend along the columns formed by the light sources to cover the corresponding light sources.
